(19) United States
(12) Patent Application Publication
(10) Pub. No.: US 2016/0078784 A1
(43) Pub. Date: Mar. 17, 2016

(54) INTERNAL ORGAN ASSEMBLY FOR CRASH TEST DUMMY

(71) Applicant: Humanetics Innovative Solutions, Inc., Plymouth, MI (US)

(72) Inventors: Kris Sullenberger, Sandusky, OH (US); Paul Depinet, Norwalk, OH (US); Michael S. Beebe, Norwalk, OH (US); Joseph H. Bastian, Brighton, MI (US); Thanh Nghi, Ann Arbor, MI (US)

(21) Appl. No.: 14/855,895

(22) Filed: Sep. 16, 2015

Related U.S. Application Data
(60) Provisional application No. 62/051,583, filed on Sep. 17, 2014.

(51) Int. Cl. G09B 23/34

(52) U.S. Cl. CPC G09B 23/34

(57) ABSTRACT

An internal organ assembly for a crash test dummy includes an organ sac having at least one internal organ to measure a regional pressure for the crash test dummy that provides for evaluation of potential abdominal injuries during vehicle crash testing. The internal organ assembly further includes an abdominal muscle layer to hold the organ sac in place and provides human-like interaction with vehicle restraints.

### CROSS-REFERENCE TO RELATED APPLICATION(S)

The present application claims the benefit of pending Provisional Patent Application, Ser. No. 62/051,583, filed Sep. 17, 2014.

### BACKGROUND OF THE INVENTION

1. Field of the Invention

The present invention relates generally to crash test dummies and, more particularly, to an internal organ assembly for a crash test dummy.

2. Description of the Related Art

Automotive, aviation, and other vehicle manufacturers conduct a wide variety of collision testing to measure the effects of a collision on a vehicle and its occupants. Through collision testing, a vehicle manufacturer gains valuable information that can be used to improve the vehicle, authorities examine vehicles to submit type approval, and consumer organizations provide information on vehicle safety ratings to the public.

Collision testing often involves the use of anthropomorphic test devices, better known as “crash test dummies”, to estimate a human's injury risk. The dummy must possess the general mechanical properties, dimensions, masses, joints, and joint stiffness of the humans of interest. In addition, they must possess sufficient mechanical impact response similitude and sensitivity to cause them to interact with the vehicle's interior in a human-like manner.

The crash test dummy typically includes a head assembly, spine assembly (including neck), rib cage or torso assembly, pelvis assembly, right and left arm assemblies, and right and left leg assemblies. Generally, the arm assembly has an upper arm assembly and a lower arm assembly. The upper arm assembly is typically connected to a shoulder assembly, which, in turn, is typically connected to the spine assembly.

Currently, there are no crash test dummies that have the capability of measuring injuries to internal organs during vehicle crash testing. As such, it is desirable to have a crash test dummy with internal organs to measure regional pressures during vehicle crash testing. It is also desirable to have a crash test dummy that represents internal organs below a diaphragm such as a liver, stomach, spleen, small intestine, and colon. It is further desirable to have a crash test dummy with internal organs fitted into a molded organ sac. It is still further desirable to provide a crash test dummy with a muscle layer and/or fat layer covering an organ sac and internal organs. Thus, there is a need in the art for an internal organ assembly for a crash test dummy that provides for evaluation of potential abdominal injuries in vehicle restraint system testing and measures injury to internal organs during vehicle crash testing.

### SUMMARY OF THE INVENTION

Accordingly, the present invention is an internal organ assembly for a crash test dummy. The internal organ assembly includes an organ sac having at least one internal organ adapted to be disposed within a torso area of the crash test dummy to measure a regional pressure for the crash test dummy that provides for evaluation of potential abdominal injuries during vehicle crash testing.

In addition, the present invention is a crash test dummy including a body and a spine assembly operatively attached to the body and a rib cage assembly operatively attached to the spine assembly. The crash test dummy also includes an internal organ assembly disposed at least partially within the rib cage assembly. The internal organ assembly includes an organ sac having at least one internal organ to measure a regional pressure for the crash test dummy that provides for evaluation of potential abdominal injuries during vehicle crash testing. The internal organ assembly further includes an abdominal muscle layer to hold the organ sac in place and provide human-like interaction with vehicle restraints.

One advantage of the present invention is that an internal organ assembly is provided for a crash test dummy. Another advantage of the present invention is that the crash test dummy includes an internal organ assembly that measures potential injuries to a thoracic region of the dummy during vehicle crash testing. Yet another advantage of the present invention is that the internal organ assembly includes an abdominal organ sac to contain the organs and hold the organs in place. Still another advantage of the present invention is that the internal organ assembly includes an abdominal muscle layer to hold the abdominal organ sac in place and provide human-like interaction with vehicle restraints. A further advantage of the present invention is that the internal organ assembly includes a fat layer that can be attached over the entire torso of the crash test dummy to represent an obese subject and the fat layer can be covered with a neoprene jacket.

Other features and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a perspective view of a crash test dummy with an internal organ assembly, according to one embodiment of the present invention.

FIG. 2 is an exploded view of the internal organ assembly and the crash test dummy of FIG. 1.

FIG. 3 is a perspective view of the internal organ assembly and the crash test dummy of FIG. 1 with a sternum, a muscle layer, and an organ sac removed.

FIG. 4 is a perspective view of the crash test dummy of FIG. 1 illustrating various fat layers and a jacket that can be attached to the crash test dummy.

FIG. 5 is a perspective view of the crash test dummy of FIG. 1 illustrating one of the fat layers and the jacket attached thereto.

### DESCRIPTION OF THE PREFERRED EMBODIMENT(S)

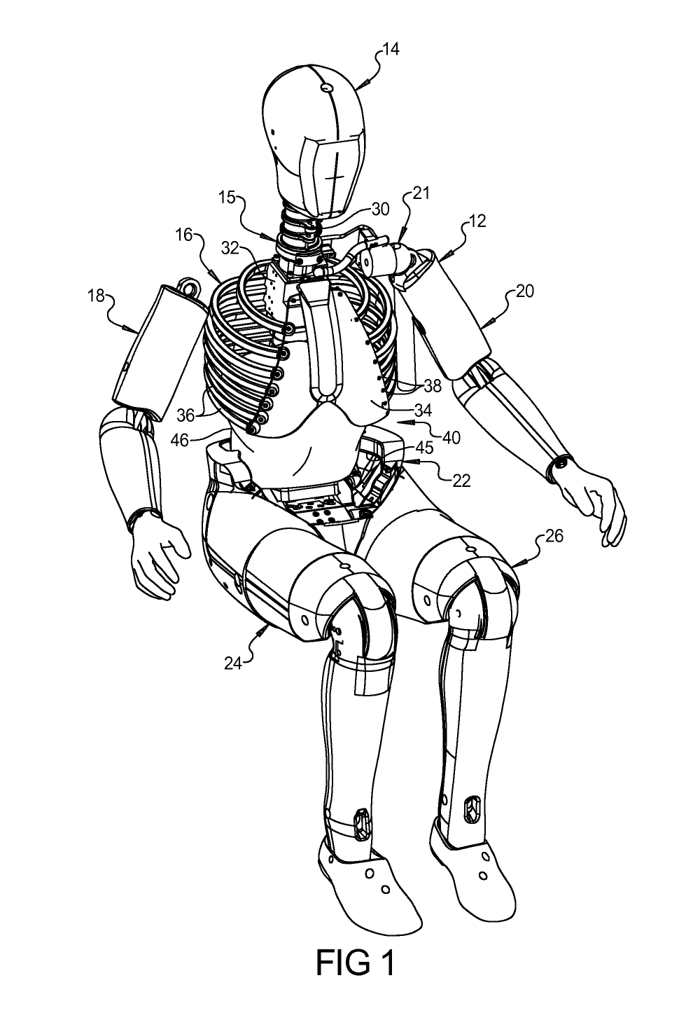

Referring to the drawings and in particular FIG. 1, one embodiment of a crash test dummy, according to the present invention, is generally indicated at 12. The crash test dummy 12 is of a fiftieth percentile (50%) male type and is illustrated in a sitting position. This crash test dummy 12 is used primarily to test the performance of vehicle interiors and restraint systems for adult front and rear seat occupants. The size and weight of the crash test dummy 12 are based on anthropometric studies, which are typically done separately by the following organizations, University of Michigan Transportation Research Institute (UMTRI), U.S. Military Anthropometry Survey (ANSUR), and Civilian American and European Surface Anthropometry Resource (CESAR). It should be appreciated that ranges of motions, centers of gravity, and segment masses simulate those of human subjects defined by the anthropometric data.

As illustrated in FIG. 1, the crash test dummy 12 includes a head assembly, generally indicated at 14. The crash test dummy 12 also includes a spine assembly, generally indicated at 15, having an upper end mounted to the head assembly 14 and a lower end extending into a torso area of the crash test dummy 12. It should be appreciated that the spine assembly 15 includes a neck 30 attached to the head assembly 14.

The torso area of the crash test dummy 12 includes a rib cage assembly, generally indicated at 16, connected to the spine assembly 15. The crash test dummy 12 also has a pair of arm assemblies including a right arm assembly, generally indicated at 18, and a left arm assembly, generally indicated at 20, which are attached to the crash test dummy 12 via a shoulder assembly, generally indicated at 21. It should be appreciated that a lower end of the spine assembly 15 is connected to a lumbar-thoracic adapter (not shown), which is connected to a lumbar to pelvic adapter (not shown).

As illustrated in the FIG. 1, the crash test dummy 12 includes a pelvis assembly, generally indicated at 22, connected to the adapter. The crash test dummy 12 includes a right leg assembly 24 and a left leg assembly 26, which are attached to the pelvis assembly 22. It should be appreciated that various components of the crash test dummy 12 may be covered in a polyvinyl skin such as a flesh and skin assembly for biofidelity of the crash test dummy 12.

The spine assembly 15 includes a neck 30 connected to the head assembly 14 and a spine box 32 connected to the neck 30. The neck 30 has a lower end connected to by a suitable attachment such as one or more fasteners (not shown) to the spine box 32. The spine box 32 is connected to the adapter by a suitable mechanism such as one or more fasteners (not shown). It should be appreciated that the fasteners threadably engage apertures (not shown) in the spine box 32 to secure the neck 30 to the spine box 32 and the spine box 32 to the adapter.

The rib cage assembly 16 includes a sternum 34 spaced forwardly from the spine box 32. The sternum 34 is generally inverted “V” shaped, but may be any suitable shape. The rib cage assembly 16 also includes one or more ribs 36 extending between the spine box 32 and sternum 34. The ribs 36 are generally arcuate in shape and generally rectangular in cross-sectional shape, but may be any suitable shape. The ribs 36 are vertically spaced along the spine box 32 and the sternum 34. The ribs 36 are connected to the spine box 32 and the sternum 34 by a suitable mechanism such as fasteners 38.

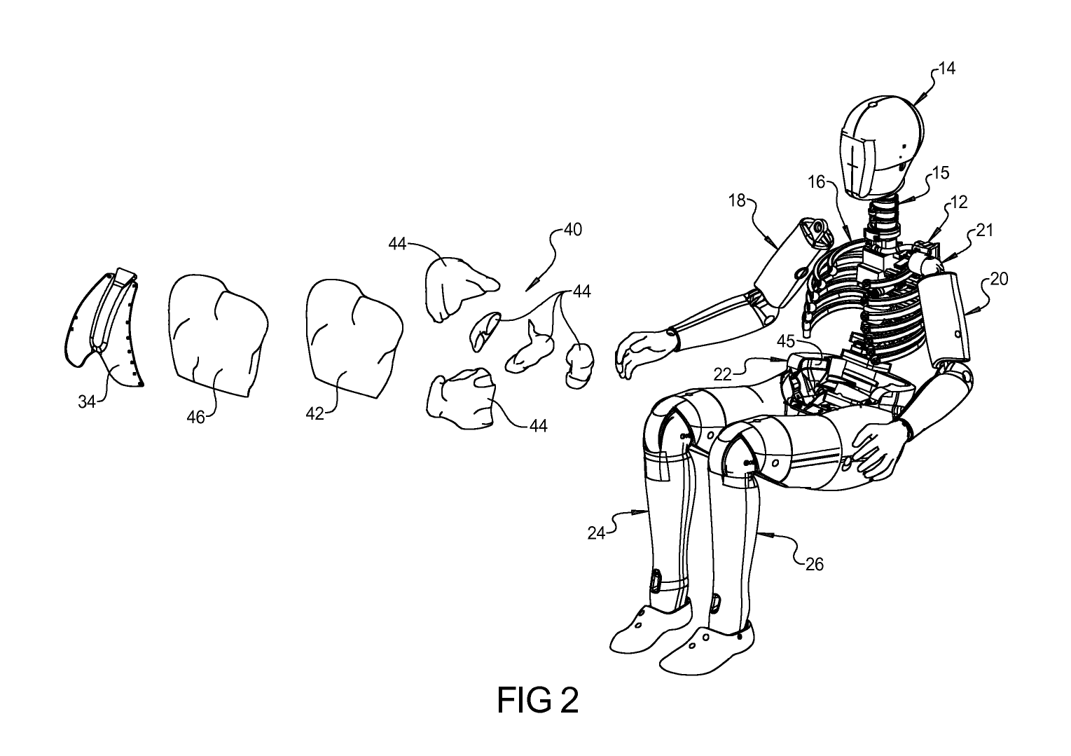

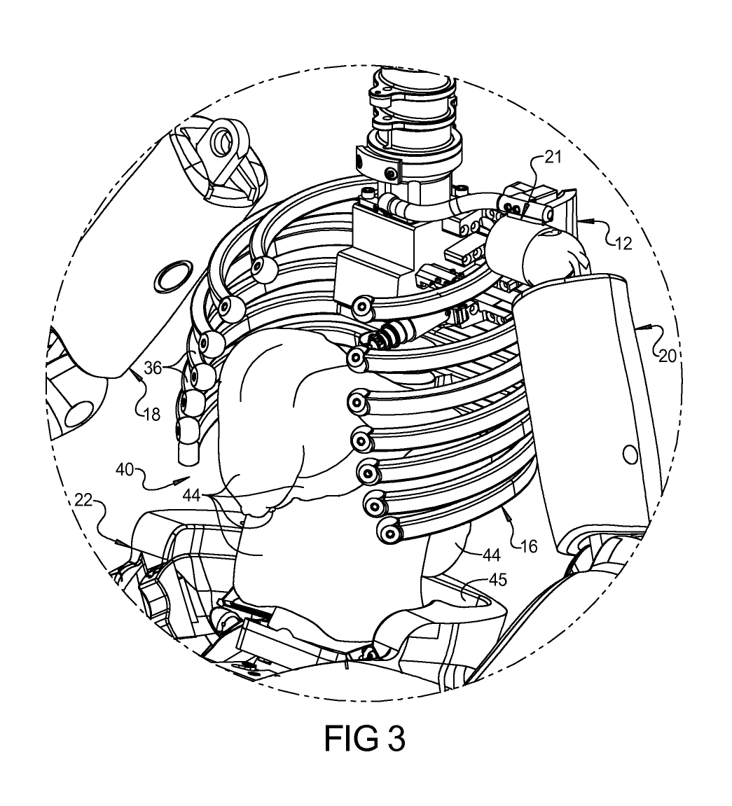

Referring to FIGS. 1 through 3, one embodiment of an internal organ assembly 40, according to the present invention, is shown for the crash test dummy 12. The internal organ assembly 40 is at least partially disposed in the rib cage assembly 16 and the pelvis assembly 22. The internal organ assembly 40 includes an abdominal or organ sac 42 having one or more internal organs 44 to measure regional pressures for a crash test dummy 12 that provides for evaluation of potential abdominal injuries during vehicle crash testing. In the embodiment illustrated, the internal organs 44 are pressure or fluid bladders that represent the liver, stomach, spleen, small intestine, and colon. The organ sac 42 is a continuous bag that contains the internal organs 44 and holds the internal organs 44 in place. The organ sac 42 is made of an elastomeric material and molded about the internal organs 44. The organ sac 42 has a portion disposed in the rib cage assembly 16 between the sternum 34 and the spine box 32 and a portion disposed in a cavity 45 of the pelvis assembly 22. It should be appreciated that the internal organs 44 are located in the crash test dummy 12 based on locations from radiology. It should also be appreciated that the internal organs 44 are disposed or contained within the organ sac 42. It should further be appreciated that the internal organs 44 have sensors (not shown) to measure regional pressures for the crash test dummy 12 that communicate with an electronic controller (not shown) and provide for evaluation of potential abdominal injuries during vehicle crash testing.

The internal organ assembly 40 further includes an abdominal muscle layer 46 to hold the organ sac 42 in place. The muscle layer 46 is a layer covering the organ sac 42. The muscle layer 46 is made of an elastomeric material. It should be appreciated that the muscle layer 46 provides human-like interaction with vehicle restraints.

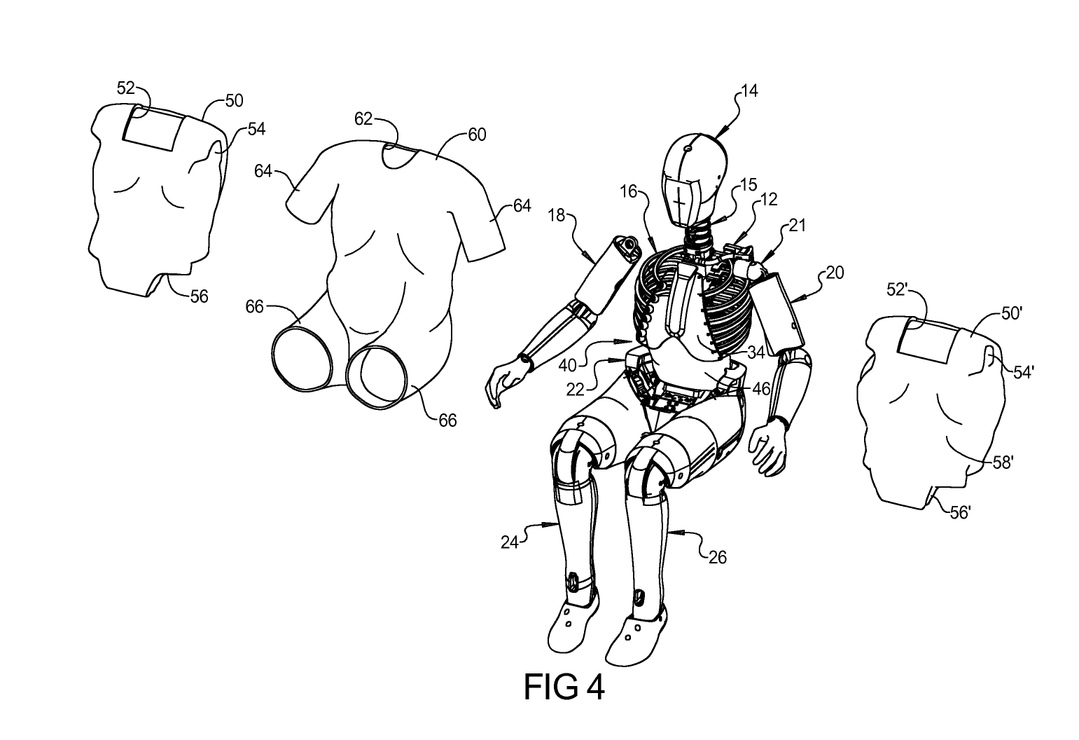

Referring to FIG. 4, the internal organ assembly 30 may include a fat layer 50 disposed over at least a portion of the torso area of the crash test dummy 12. In one embodiment, the fat layer 50 is a continuous bag having a hollow interior that has an upper central opening 52 to allow the neck 30 to extend therethrough, upper side openings 54 to allow the arm assemblies 18, 20 to extend therethrough, and lower side openings 56 to allow the leg assemblies 24, 26 to extend therethrough. The fat layer 50 is made of an elastomeric material. In another embodiment, the fat layer 50′ is a continuous bag having a hollow interior that has an upper central opening 52′ to allow the neck 30 to extend therethrough, upper side openings 54′ to allow the arm assemblies 18, 20 to extend therethrough, and lower side openings 56′ to allow the leg assemblies 24, 26 to extend therethrough. The fat layer 50′ may have additional material portions 58′ to represent an obese person. It should be appreciated that the fat layer 50, 50′ is disposed over the entire torso of the crash test dummy 12 and the internal organs 44 may need adjustment for an obese dummy.

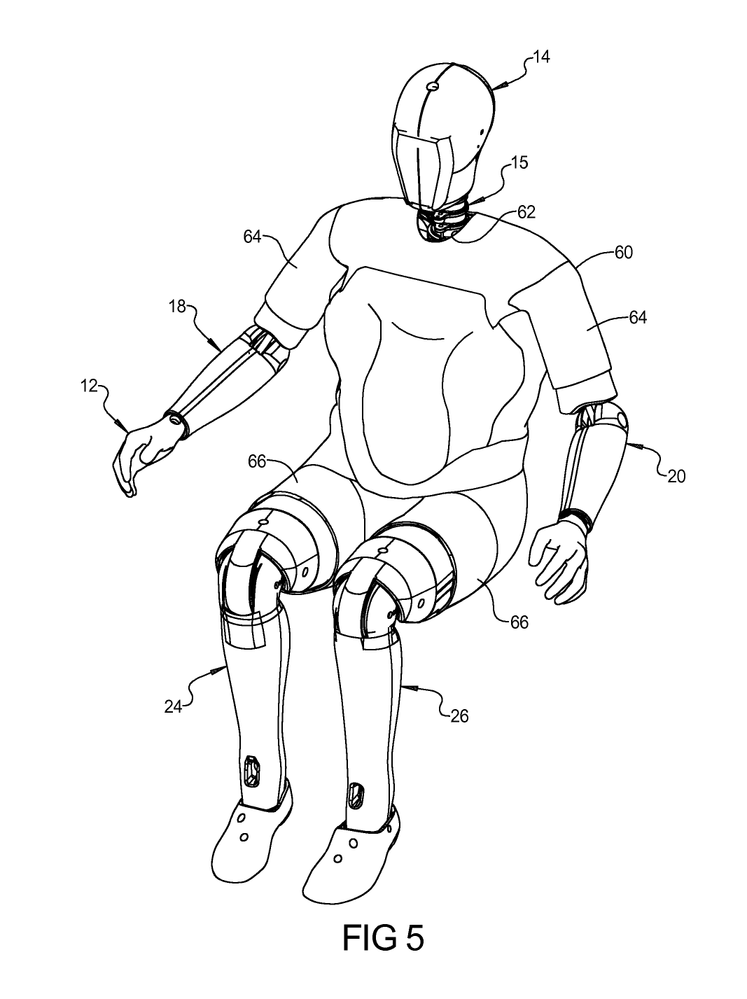

Referring to FIGS. 4 and 5, the internal organ assembly 40 may include a jacket 60 to cover the fat layer 50, 50′. In one embodiment, the jacket 60 is a continuous bag having a hollow interior that has an upper central opening 62 to allow the neck 30 to extend therethrough, upper side sleeves 64 to allow the arm assemblies 18, 20 to extend therethrough, and lower side sleeves 66 to allow the leg assemblies 24, 26 to extend therethrough. The jacket 60 is made of a neoprene material. It should be appreciated that the jacket 60 is optional and may be used to represent an elderly or obese person.

Accordingly, the internal organ assembly 40 of the present invention allows the crash test dummy 12 to have internal organs 44 to measure regional pressures and measure potential injuries to a thoracic region of the dummy 12 during crash testing. In addition, the internal organ assembly 40 of the present invention provides a crash test dummy 12 that represents internal organs 44 below a diaphragm such as a liver, stomach, spleen, small intestine, and colon. The internal organ assembly 40 has a crash test dummy 12 with internal organs 44 fitted into a molded organ sac 42 to contain the organs 44 and hold the organs 44 in place to mimic that of a human being. The crash test dummy 12 with the internal organ assembly 40 has a muscle layer 46 to hold the abdominal organ sac 42 in place and provide human-like interaction with vehicle restraints. In addition, the crash test dummy 12 with the internal organ assembly 40 may include a fat layer 50 that can be attached over the entire torso area to represent an obese subject and the fat layer 50 can be covered with a neoprene jacket 60. Further, the crash test dummy 12 with internal organ assembly 40 provides for evaluation of vehicle restraint system testing and is a surrogate to mimic potential abdominal injuries in vehicle restraint system testing for different modes of impact during vehicle crash tests and measures injury to internal organs during vehicle crash testing.

The present invention has been described in an illustrative manner. It is to be understood that the terminology, which has been used, is intended to be in the nature of words of description rather than of limitation.

Many modifications and variations of the present invention are possible in light of the above teachings. Therefore, the present invention may be practiced other than as specifically described.

What is claimed is:

1. An internal organ assembly for a crash test dummy comprising:
an organ sac having at least one internal organ adapted to be disposed within a torso area of the crash test dummy to measure a regional pressure for the crash test dummy that provides for evaluation of potential abdominal injuries during vehicle crash testing.

2. An internal organ assembly as set forth in claim 1 including a muscle layer disposed over said organ sac to hold said organ sac in place in the crash test dummy.

3. An internal organ assembly as set forth in claim 2 wherein said organ sac has a portion adapted to be disposed within a rib cage of the crash test dummy and a portion adapted to be disposed within a pelvis of the crash test dummy.

4. An internal organ assembly as set forth in claim 1 including a fat layer adapted to be disposed over the torso area.

5. An internal organ assembly as set forth in claim 4 including a jacket disposed over said fat layer.

6. An internal organ assembly as set forth in claim 5 wherein said jacket has lower sleeves adapted to allow legs of the crash test dummy to extend therethrough.

7. An internal organ assembly as set forth in claim 5 wherein said jacket has upper sleeves adapted to allow arms of the crash test dummy to extend therethrough.

8. An internal organ assembly as set forth in claim 5 wherein said jacket is made of a neoprene material.

9. A crash test dummy comprising:
a body;
a spine assembly operatively attached to said body; and
a rib cage assembly operatively attached to said spine assembly; and
an internal organ assembly disposed at least partially within said rib cage assembly including an organ sac having at least one internal organ to measure a regional pressure for the crash test dummy that provides for evaluation of potential abdominal injuries during vehicle crash testing.

10. A crash test dummy as set forth in claim 9 including a muscle layer disposed over said organ sac to hold said organ sac in place in said crash test dummy.

11. A crash test dummy as set forth in claim 10 wherein said organ sac has a portion disposed within said rib cage assembly and a portion disposed within a pelvis assembly of said crash test dummy.

12. A crash test dummy as set forth in claim 9 including a fat layer adapted to be disposed over said rib cage assembly.

13. A crash test dummy as set forth in claim 12 including a jacket disposed over said fat layer.

14. A crash test dummy as set forth in claim 13 wherein said jacket has lower sleeves to allow legs of said crash test dummy to extend therethrough.

15. A crash test dummy as set forth in claim 13 wherein said jacket has upper sleeves to allow arms of said crash test dummy to extend therethrough.

16. A crash test dummy as set forth in claim 13 wherein said jacket is made of a neoprene material.
